(19) United States
(12) Patent Application Publication
(10) Pub. No.: US 2013/0209157 A1
(43) Pub. Date: Aug. 15, 2013

(54) Tape Holding Device

(71) Applicant: SDI Corporation, (US)

(72) Inventors: Che-Chang Cheng, Chang Hua (TW); Yenwen Hung, Chang Hua (TW)

(73) Assignee: SDI Corporation, Chang Hua (TW)

(21) Appl. No.: 13/761,312

(22) Filed: Feb. 7, 2013

(30) Foreign Application Priority Data
Feb. 15, 2012 (TW) 101104891

(51) Int. Cl. B05C 17/00

(52) U.S. Cl. CPC B05C 17/00
USPC 401/88

(57) ABSTRACT

A tape holding device has a holding frame and an engaging component. The holding frame has a connecting segment and at least one elastic arm connected to the connecting component. The at least one elastic arm is elastic and can swing relative to the connecting segment. The engaging component is formed on the at least one elastic arm away from the connecting segment and has at least one engaging tab. The at least one engaging tab is formed on and protrudes from an inner surface of the at least one elastic arm that is opposite to the holding frame to abut and engage a tape supplying wheel of a dispensing unit to limit the rotation of the tape supplying wheel. The tape holding device prevents a tape from loosening, prevents a thin film on the tape from peeling and can be used to replace a new dispensing unit conveniently.

### BACKGROUND OF THE INVENTION

1. Field of the Invention

The present invention relates to a tape holding device, and more particularly to a tape holding device for a thin film dispenser to prevent the tape from loosening, to prevent a thin film on the tape from peeling and to replace a new dispensing unit conveniently.

2. Description of Related Art

With reference to FIG. 15, a conventional correction tape dispenser is stationery that can be used for a user to dispense a correction tape onto a sheet of paper or the like to correct errors on the paper. The conventional correction tape dispenser has a housing and a correction tape dispensing unit 70. The correction tape dispensing unit 70 is mounted in the housing and has a body 71, a dispensing head 72, a wheel assembly 73 and a tape 74. The dispensing head 72 is mounted on one end of the body 71. The wheel assembly 73 is mounted on the other end of the body 71 and has a tape supplying wheel 731 and a used tape collecting wheel 732. The wheels 731, 732 are mounted rotatably on the other end of the body 71 and are driven to rotate with each other. The tape 74 is mounted around the wheel assembly 73 and the dispensing head 72.

In addition, in manufacturing and assembling the conventional correction tape dispenser, in order to prevent the tape 74 from loosening and to prevent a user from touching the thin film on the tape 74 to cause the thin film peeling before the correction tape dispensing unit 70 being mounted in the housing, a paper holder 80 is mounted around the correction tape dispensing unit 70 to wedge the tape supplying wheel 731. This can be used to limit the rotation of the tape supplying wheel 731 to prevent the tape 74 from loosening. Furthermore, the paper holder 80 is mounted around the sides of the tape 74 to prevent the thin film on the tape 74 from peeling.

Although the tap supplying wheel 731 of the conventional correction tape dispenser can be held by the paper holder 80 to prevent the tape 74 from loosening during the transporting process, the paper holder 80 has to be detached from the correction tape dispensing unit 70 before the correction tape dispensing unit 70 is assembled into the housing. However, the tape supplying wheel 731 can rotate freely without the holding of the paper holder 80 during the assembling process. Then, in assemblement, the tape 74 may be loosening easily and the hands of the user may touch the tape 74 to cause the thin film peeling the tape 74 and this is inconvenient in use. In addition, in production, the paper holder 80 is needed to mount around the correction tape dispensing unit 70 and this will increase the cost and time of manufacture.

The tape holding device in accordance with the present invention mitigates or obviates the aforementioned problems.

### SUMMARY OF THE INVENTION

The main objective of the invention is to provide a tape holding device for a thin film dispenser that can prevent the tape from loosening, can prevent a thin film on the tape from peeling and can be used to replace a new dispensing unit conveniently.

The tape holding device in accordance with the present invention has a holding frame and an engaging component. The holding frame has a connecting segment and at least one elastic arm connected to the connecting component. The at least one elastic arm is elastic and can swing relative to the connecting segment. The engaging component is formed on the at least one elastic arm away from the connecting segment and has at least one engaging tab. The at least one engaging tab is transversally formed on and protrudes from an inner surface of the at least one elastic arm relative to the holding frame to abut and engage a tape supplying wheel of a dispensing unit to limit the rotation of the tape supplying wheel. The tape holding device can prevent a tape from loosening, can prevent a thin film on the tape from peeling and can be used to replace a new dispensing unit conveniently.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a tape holding device in accordance with the present invention;

FIG. 2 is an operational top view of the tape holding device in FIG. 1 mounting with a dispensing unit;

FIG. 3 is an operational cross sectional side view of the tape holding device in FIG. 2;

FIG. 4 is a top view of the tape holding device in FIG. 1 mounting with a dispensing unit;

FIG. 5 is a side view in partial section of the tape holding device in FIG. 4;

FIG. 6 is a cross sectional side view of the tape holding device along line 6-6 in FIG. 4;

FIG. 7 is a cross sectional side view of the tape holding device along line 7-7 in FIG. 4;

FIG. 8 is a perspective view of the tape holding device in FIG. 1 mounting with a dispensing unit;

FIG. 9 is a perspective view of the tape holding device in FIG. 8 mounting in a housing of a thin film dispenser;

FIG. 10 is an operational perspective view of the tape holding device in FIG. 9;

FIG. 11 is a perspective view of a second embodiment of a tape holding device in accordance with the present invention;

FIG. 12 is an operational top view of the tape holding device in FIG. 11 mounting with a dispensing unit;

FIG. 13 is another operational top view of the tape holding device in FIG. 11 mounting with a dispensing unit;

FIG. 14 is a perspective view of the tape holding device in FIG. 11 mounting with a dispensing unit; and

FIG. 15 is an exploded perspective view of a paper holder in accordance with the prior art with a dispensing unit.

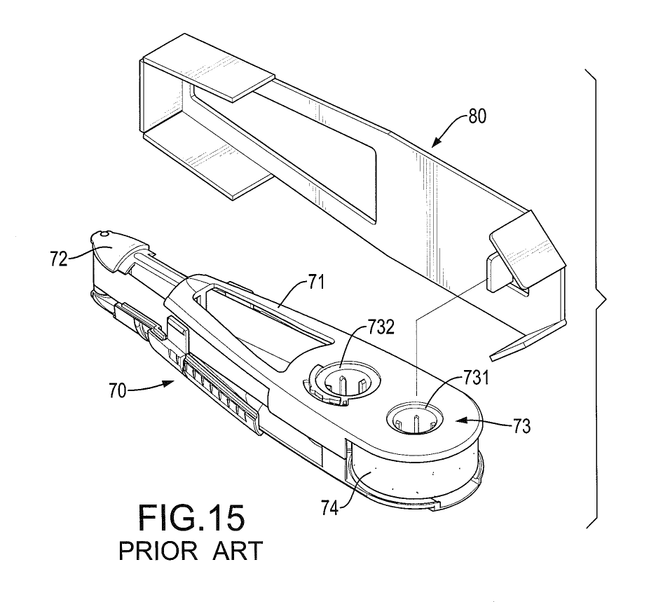

### DETAILED DESCRIPTION OF PREFERRED EMBODIMENT

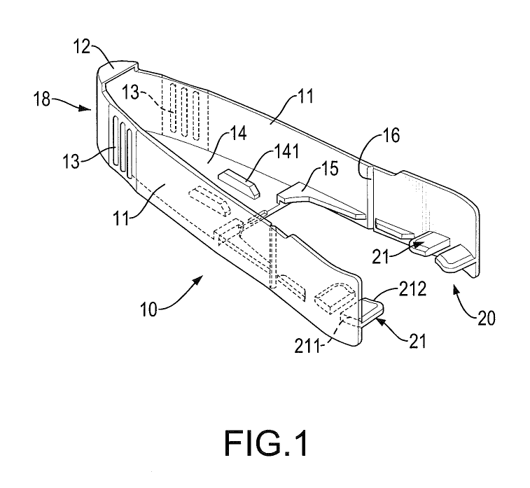

With reference to FIG. 1, a tape holding device of a first embodiment in accordance with the present invention comprises a holding frame 10 and an engaging component 20.

The holding frame 10 is a V-shaped elastic frame that may be made of metal, plastic, rubber or paper, and has a connecting segment 18 and at least one elastic arm 11 connected to the connecting segment 18. The at least one elastic arm 11 can be swung relative to the connecting segment 18. Preferably, the holding frame 10 has two elastic arms 11 connected to the connecting segment 18, and the elastic arms 11 can be moved close to or away from each other. The holding frame 10 has a semicircular limiting panel 12 transversally formed on a top of the connecting segment 18. Each of the elastic arms 11 has a free end opposite to the connecting segment 18.

In addition, with reference to FIG. 1, the holding frame 10 has multiple skidproof bars 13 longitudinally formed on and protruding from the external surfaces of the elastic arms 11 at intervals adjacent to the connecting segment 18. The holding frame 10 has a cover 14 transversally formed on a bottom of the connecting segment 18 and extending to the middles of the elastic arms 11. The cover 14 has an inner side facing to the limiting panel 12 and two supporting ribs 141 formed on and protruding from the inner side at an interval. Furthermore, the holding frame 10 has two abutting slices 15 respectively formed on and protruding from the inner surfaces of the elastic arms 11 and connected to the cover 14. In addition, each abutting slice 15 has a height difference relative to the cover 14. Furthermore, each elastic arm 11 has a groove 16 longitudinally formed in the inner surface of the elastic arm 11 adjacent to the engaging component 20 to make the free end of the elastic arm 11 to swing inwardly or outwardly.

The engaging component 20 is connected to the at least one elastic arm 11 away from the connecting segment 18 and has at least one engaging tab 21 transversally formed on and protruding from the at least one elastic arm 11 relative to the holding frame 10. Preferably, the inner surface of the elastic arm 11 faces to the inner surface of the other elastic aim 11 and the at least one engaging tab 21 is formed on and protrudes from the inner surface of each of the elastic arms 11 adjacent to the free end of the corresponding elastic arm 11. Each of the at least one engaging tab 21 has a connecting end 211 and an engaging end 212. In the first embodiment of the tape holding device, the connecting end 211 of the engaging tab 21 is connected to the inner surface of a corresponding elastic arm 11. The engaging end 212 of the engaging tab 21 extends inwardly to the interior of the holding frame 10. Preferably, the engaging component 20 has two engaging tabs 21 formed on and protruding from each of the elastic arms 11 at an interval. The connecting end 211 of the engaging tab 21 has a thickness thicker than a thickness of the engaging end 212 of the engaging tab 21.

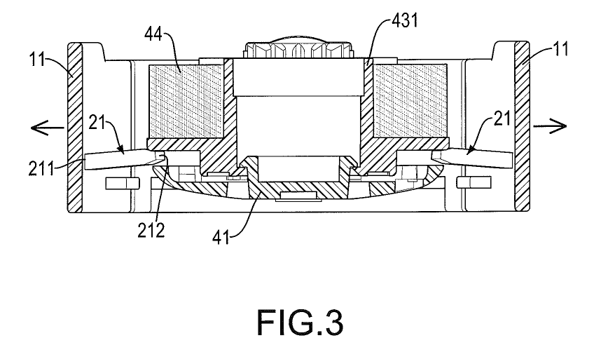

With reference to FIG. 3, the engaging end 212 of the engaging tab 21 has an oblique angle relative to the inner surface of the corresponding elastic arm 11. In addition, the engaging end 212 of the engaging tab 21 has an advance angle.

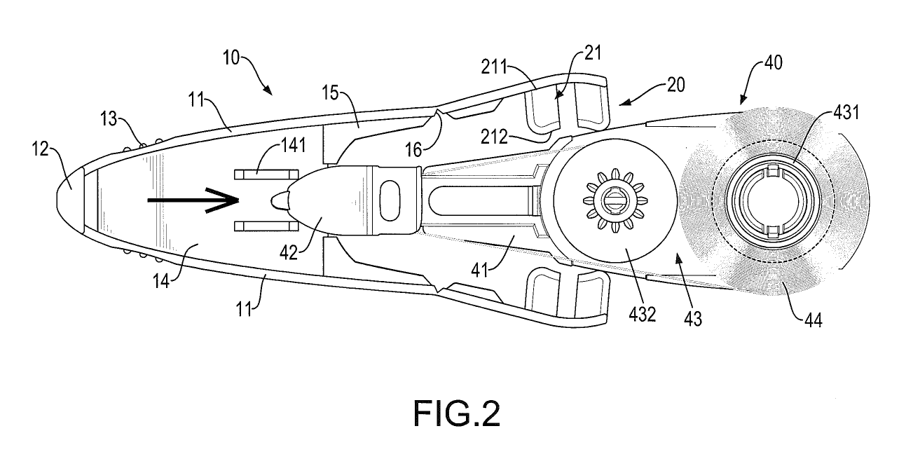

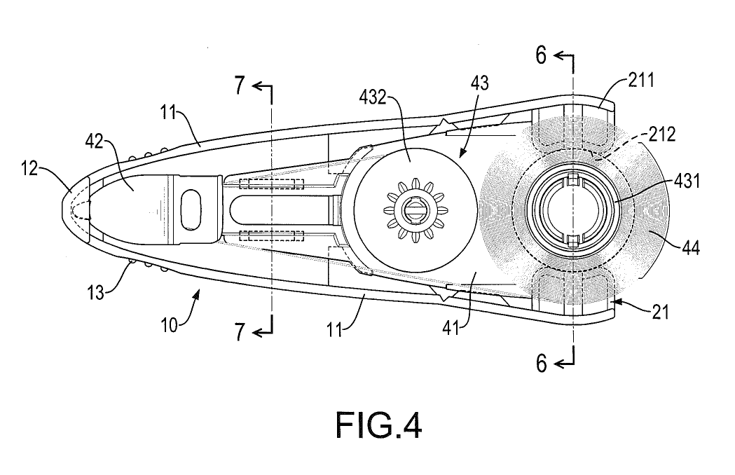

With reference to FIGS. 2 to 4, the tape holding device of the first embodiment in accordance with the present invention is assembled with a dispensing unit 40, the dispensing unit 40 has a body 40, a dispensing head 42, a wheel assembly 43 and a tape 44. The wheel assembly 43 has a tape supplying wheel 431 and a used tape collecting wheel 432. The structure of the dispensing unit 40 may be conventional and does not be further stated.

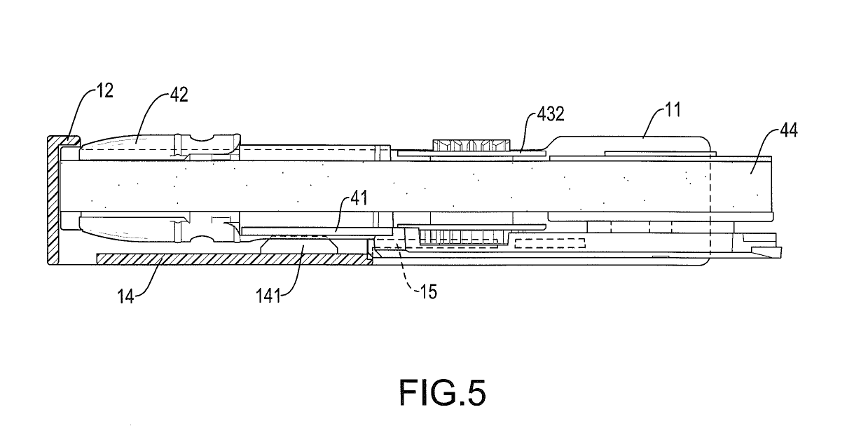

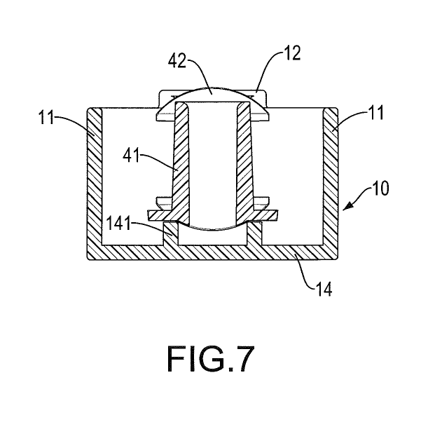

When an assembler uses the tape holding device of the first embodiment in accordance with the present invention to connect to the dispensing unit 40, the elastic arms 11 of the holding frame 10 are moved toward the wheel assembly 43 of the dispensing unit 40 to enable the body 41 to abut the supporting ribs 141 and to move along the cover 14 as shown in FIG. 5. Then, the dispensing head 42 can be moved in the holding frame 10 below the limiting panel 12 as shown in FIG. 7 and this can provide a positioning effect to the dispensing unit 40. Additionally, the abutting slices 15 and the supporting ribs 141 abut the body 41 to provide a preferred abutting effect to the dispensing unit 40. Thus, the dispensing unit 40 can be securely connected to the tape holding device of the first embodiment in accordance with the present invention.

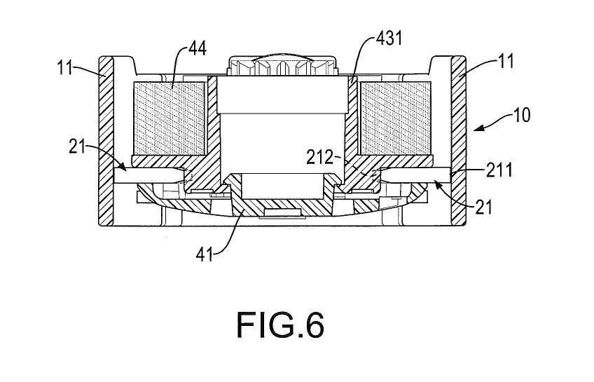

When the free ends of the elastic arms 11 are moved to the sides of the tape supplying wheel 431, the free ends of the elastic arms 11 are pressed to move close to the tape supplying wheel 431 due to the elasticity of the elastic arms 11. Then, the engaging ends 212 of the engaging tabs 21 that are formed on and protrude from the inner surfaces of the elastic arms 11 can be moved and extend into a gap that is formed between the body 41 and the tape supplying wheel 431 as shown in FIG. 6. The width of the gap is larger than the thickness of the engaging end 212 and is smaller than the thickness of the connecting end 211 of the engaging tab 21. Therefore, the engaging ends 212 of the engaging tabs 21 can abut against the tape supplying wheel 431. Due to the thicker thickness of the connecting end 211 than the thickness of the engaging end 212 of the engaging tab 21, the engaging tabs can engage the tape supplying wheel 431 to hold the tape supplying wheel 431 without rotating. Consequently, when the tape supplying wheel 431 is held with the engaging tabs 21, the tape 44 that is mounted on the tape supplying wheel 431 cannot be loosen.

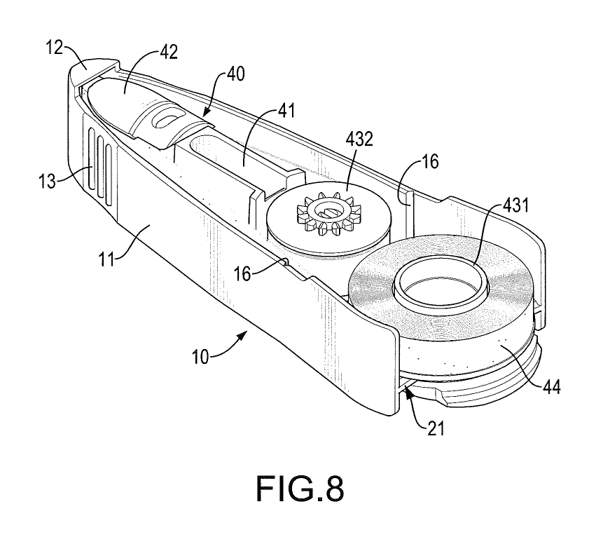

Furthermore, when the tape holding device connects to the dispensing unit 40, the grooves 16 of the elastic arms 11 can make the elastic arms 11 more flexible and this can prevent the elastic arms 11 from interfering with the body 41 in assembling. In addition, with reference to FIG. 3, the structure features of the engaging end 212 of the engaging tab 21 having an oblique angle relative to the inner surface of a corresponding elastic arm 11 and the engaging end 212 of the engaging tab 21 having an advance angle can provide a guiding effect to the engaging tabs 21 when the engaging tabs 21 are inserted into the gap between the body 41 and the tape supplying wheel 431. Then, the engaging tabs 21 can be moved in the gap between the body 41 and the tape supplying wheel 431 smoothly and easily. With reference to FIG. 8, the tape holding device of the first embodiment in accordance with the present invention has been assembled with the dispensing unit 40.

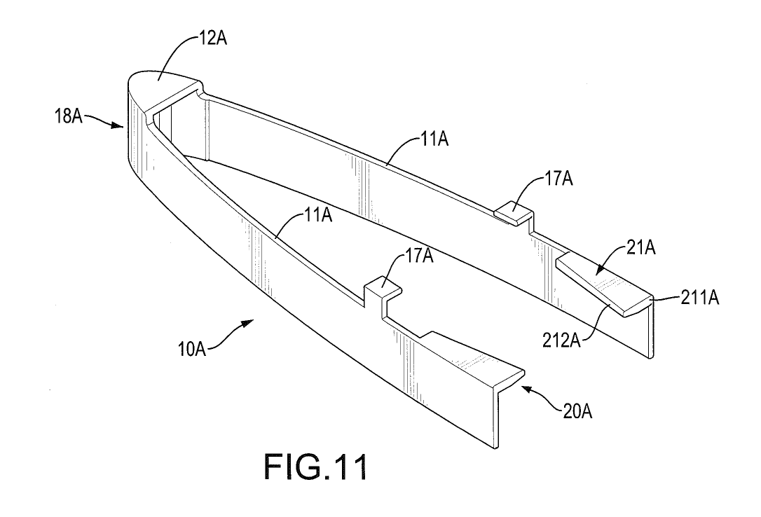

With further reference to FIG. 11, the tape holding device of a second embodiment in accordance with the present invention has a holding frame 10A and an engaging component 20A.

The holding frame 10A is a V-shaped elastic frame that may be made of metal, plastic, rubber or paper, and has a connecting segment 18A and at least one elastic arm 11A connected to the connecting segment 18A. The at least one elastic arm 11A can be swung relative to the connecting segment 18A. Preferably, the holding frame 10A has two elastic arms 11A connected to the connecting segment 18A, and the elastic arms 11A can be moved close to or away from each other. The holding frame 10A has a semicircular limiting panel 12A transversally formed on a top side of the connecting segment 18A. Each of the elastic arms 11A has a free end opposite to the connecting segment 18A. Preferably, each elastic arm 11A has a top side at the same side as the top side of the connecting segment 18A and an L-shaped positioning slice 17A formed on and protruding from the top side of the elastic aim 11A.

The engaging component 20A is connected to the at least one elastic arm 11A away from the connecting segment 18A and has at least one engaging tab 21A transversally formed on and protruding from the at least one elastic arm 11A relative to an interior of the holding frame 10A. Preferably, the inner surface of the elastic arm 11A faces to the inner surface of the other elastic arm 11A and the at least one engaging tab 21A is formed on and protrudes from the inner surfaces of the elastic arms 11A adjacent to the free ends of the elastic arms 11A. Each of the at least one engaging tab 21A has a connecting end 211A and an engaging end 212A. In the second embodiment of the tape holding device, the connecting end 211A of the engaging tab 21A is connected to the inner surface of a corresponding elastic arm 11A. The engaging end 212A of the engaging tab 21A extends inwardly to the interior of the holding frame 10A.

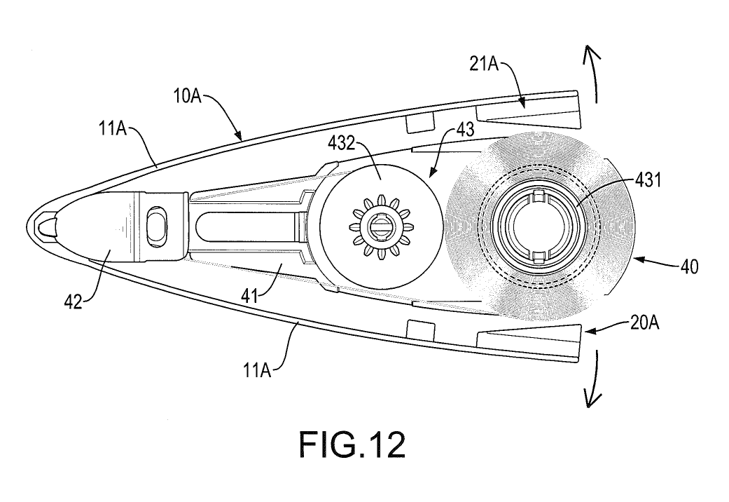

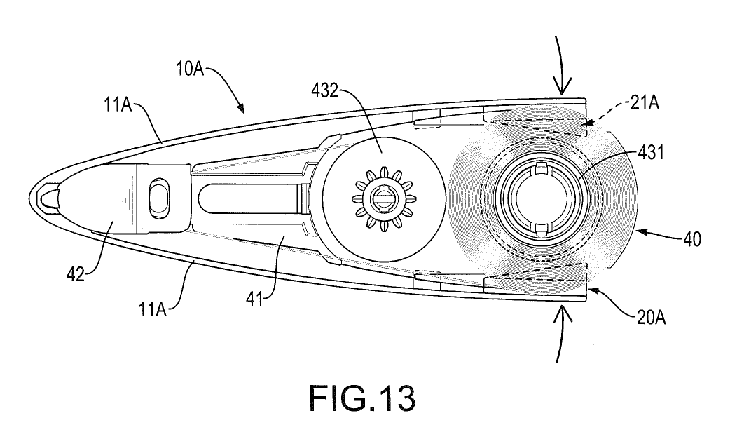

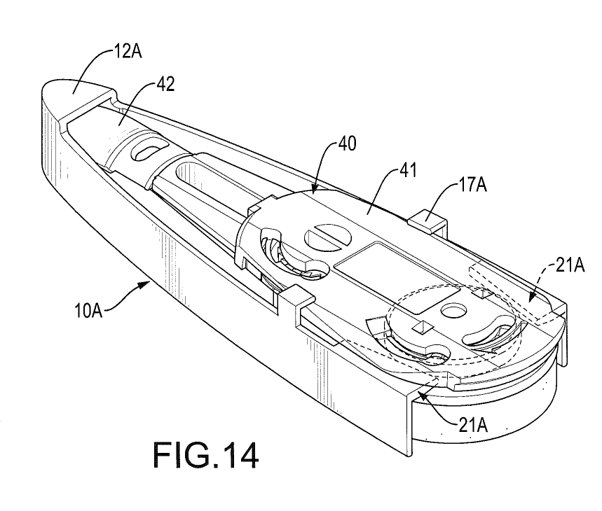

Furthermore, with reference to FIGS. 12 and 13, the tape holding device of the second embodiment in accordance with the present invention is assembled with the dispensing unit 40, the elastic arms 11A of the holding frame 10A are swung outwardly and are moved toward the wheel assembly 43 of the dispensing unit 40 to enable the dispensing head 42 to move in the holding frame 10A below the limiting panel 12A as shown in FIG. 14 and this can provide a positioning effect to the dispensing unit 40. Additionally, with reference to FIG. 14, the positioning slices 17A that are formed on and protruding from the elastic arms 11A can abut the body 41 to provide a further abutting effect to the dispensing unit 40. Thus, the dispensing unit can be securely connected to the tape holding device of the second embodiment in accordance with the present invention.

When the free ends of the elastic arms 11A are moved to the sides of the tape supplying wheel 431, the elasticity of the elastic arms 11A can enable the free ends of the elastic arms 11A to move toward the tape supplying wheel 431. In addition, the structure features of the engaging end 212A of the engaging tab 21A having an oblique angle relative to the inner surface of a corresponding elastic arm 11A and the engaging end 212A of the engaging tab 21A having an advance angle can provide a guiding effect to the engaging tabs 21A when the engaging tabs 21A are inserted into the gap between the body 41 and the tape supplying wheel 431.

The structure and assemblement of the tape holding device of the second embodiment in accordance with the present invention have been described above, the next instruction is about a replacing operation of the tape holding device in accordance with the present invention with the dispensing unit 40 for a correction tape dispenser.

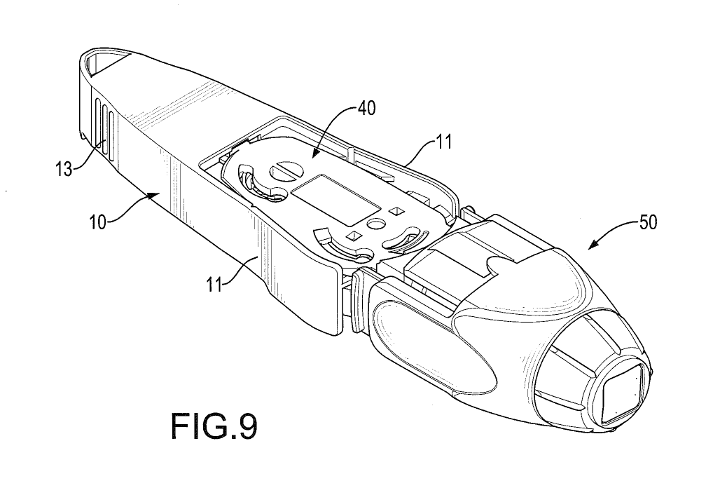

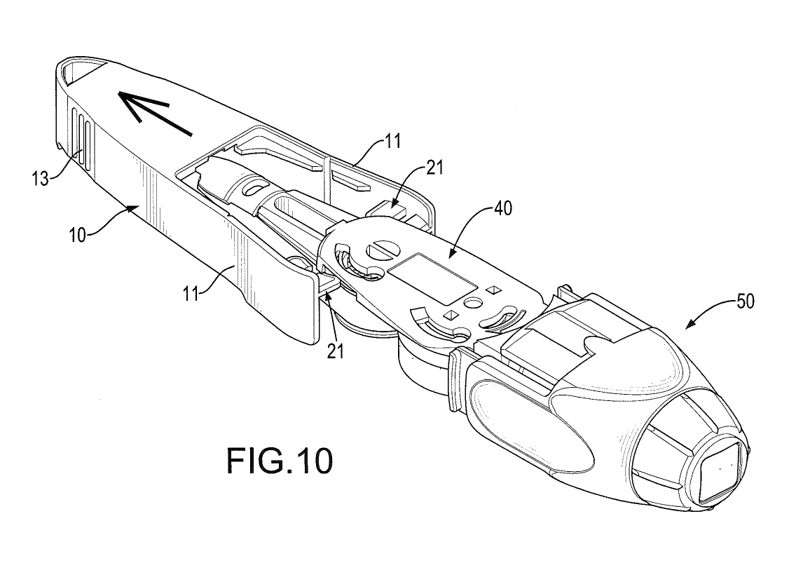

With reference to FIGS. 9 and 10, when the dispensing unit 40 with the tape holding device of the first embodiment in accordance with the present invention is mounted in a housing 50 of a thin film dispenser, a user can holds the elastic arms 11 of the holding frame 10 to insert and mount the dispensing unit 40 securely in the housing 50. After the dispensing unit 40 being mounted securely in the housing 50, the user can hold and press the skidproof bars 13 to pull the holding frame 10 to enable the elastic arms 11 to deform and to move outwardly relative to the dispensing unit 40. Then, the engaging tabs 21 can be separated from the tape supplying wheel 431 and the dispensing unit 40 can be mounted in the thin film dispenser conveniently.

Similarly, when the dispensing unit 40 with the tape holding device of the second embodiment in accordance with the present invention is mounted in a housing 50 of a thin film dispenser, the user can holds the elastic arms 11A of the holding frame 10A to insert and mount the dispensing unit 40 securely in the housing 50. After the dispensing unit 40 mounting securely in the housing 50, the user can hold and press the external surfaces of the elastic arms 11A to pull the holding frame 10A to enable the elastic arms 11A to deform and to move outwardly relative to the dispensing unit 40. Then, the engaging ends 212A of the engaging tabs 21A can be separated from the tape supplying wheel 431 and the dispensing unit 40 can be mounted in the thin film dispenser conveniently.

By the above technology, the elastic arms 11, 11A of the holding frame 10, 10A of the tape holding device of the present invention can be deformed elastically, and this can enable the engaging tabs 21, 21A that are formed on the elastic arms 11, 11A to abut and engage the tape supplying wheel 431 of the dispensing unit 40, and the rotation of the tape supplying wheel 431 can be limited. Then, the tape 44 that mounted around the tape supplying wheel 431 will not be loosen by the un-rotating tape supplying wheel 431 and this can prevent the tape 44 from loosening when mounting or replacing the dispensing unit 40 in the housing 50.

In addition, when the thin film dispenser is needed to assemble or replace with a dispensing unit 40, the dispensing unit 40 can be mounted in the housing 50 of the thin film dispenser conveniently without separating from the tape holding device in accordance with the present invention, and this can prevent the hands of the user from touching the sides of the tape 44 and avoid the thin film of the tape 44 peeling during the mounting or replacing process. Contrarily; the conventional paper holder 80 is needed to be separated from the correction tape dispensing unit 70 before the correction tape dispensing unit 70 assembling or replacing in the housing 50 of a thin film dispenser, and the hands of the user may touch the tape 74 of the correction tape dispensing unit 70 to cause the thin film to crumble during the assembling or replacing process. Therefore, the tape holding device in accordance with the present invention can prevent the tape 44 from loosening, can prevent a thin film on the tape 44 from peeling and can be used to replace a new dispensing unit 40 conveniently.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tape holding device comprising:
a holding frame having
a connecting segment; and
at least one elastic arm connected to the connecting segment and being elastic to swing relative to the connecting segment; and
an engaging component connected to the at least one elastic arm away from the connecting segment and having at least one engaging tab transversally formed on and protruding from an inner surface of the at least one elastic arm relative to the holding frame.

2. The tape holding device as claimed in claim 1, wherein the holding frame has two elastic arms connected to the connecting segment to move close to or away from each other.

3. The tape holding device as claimed in claim 2, wherein
each of the elastic arms has a free end opposite to the connecting segment; and
the at least one engaging tab of the engaging component is transversally formed on and protrudes from the inner surface of each elastic arm at a position adjacent to the free end of the elastic arm.

4. The tape holding device as claimed in claim 3, wherein the holding frame has a limiting panel transversally formed on a top of the connecting segment.

5. The tape holding device as claimed in claim 4, wherein the holding frame has multiple skidproof bars longitudinally formed on the external surfaces of the elastic arms at intervals adjacent to the connecting segment.

6. The tape holding device as claimed in claim 5, wherein
the holding frame has a cover transversally formed on a bottom of the connecting segment and extending to middles of the elastic arms; and
the cover has an inner side facing to the limiting panel and two supporting ribs formed on and protruding from the inner side of the cover at an interval.

7. The tape holding device as claimed in claim 6, wherein the holding frame has two abutting slices respectively formed on and protruding from the inner surfaces of the elastic arms, connected to the cover and each abutting slice having a height difference relative to the cover.

8. The tape holding device as claimed in claim 7, wherein each of the elastic arms has a groove longitudinally formed in the inner surface adjacent to the engaging component.

9. The tape holding device as claimed in claim 1, wherein each one of the at least one elastic arm has a groove longitudinally formed in the inner surface of the at least one elastic arm at a position adjacent to the engaging component.

10. The tape holding device as claimed in claim 1, wherein the holding frame has multiple skidproof bars longitudinally formed on the external surface of the at least one elastic arm at intervals adjacent to the connecting segment.

11. The tape holding device as claimed in claim 1, wherein the holding frame has a cover transversally formed on a bottom of the connecting segment and extending to a middle of the at least one elastic arm.

12. The tape holding device as claimed in claim 4, wherein the cover has an inner side facing to the limiting panel and two supporting ribs formed on and protruding from the inner side of the cover at an interval.

13. The tape holding device as claimed in claim 1, wherein each one of the at least one engaging tab has
a connecting end connected to the inner surface of a corresponding one of the at least one elastic arm; and
an engaging end extending inwardly to an interior of the holding frame.

14. The tape holding device as claimed in claim 13, wherein the engaging end of each one of the at least one engaging tab extends to the corresponding elastic arm at an oblique angle relative to the inner surface of the corresponding elastic arm and has an advance angle.

15. The tape holding device as claimed in claim 4, wherein each elastic arm has a positioning slice formed on and protruding from a top side of the elastic arm that at the same side as the limiting panel.

16. The tape holding device as claimed in claim 1, wherein the holding frame is an elastic frame that is made of metal, plastic, rubber or paper.

17. The tape holding device as claimed in claim 1, wherein the holding frame is a V-shaped elastic frame.

18. The tape holding device as claimed in claim 15, wherein the positioning slice is L-shaped.

19. The tape holding device as claimed in claim 2, wherein the holding frame has a limiting panel formed transversally formed on a top of the connecting segment.

20. The tape holding device as claimed in claim 19, wherein the holding frame has multiple skidproof bars longitudinally formed on the external surfaces of the elastic arms at intervals adjacent to the connecting segment.

21. The tape holding device as claimed in claim 20, wherein
the holding frame has a cover transversally formed on a bottom of the connecting segment and extending to the middles of the elastic arms; and
the cover has an inner side facing to the limiting panel and two supporting ribs formed on and protruding from the inner side of the cover at an interval.

22. The tape holding device as claimed in claim 21, wherein the holding frame has two abutting slices respectively formed on and protruding from the inner surfaces of the elastic arms, connected to the cover and each abutting slice having a height difference relative to the cover.

23. The tape holding device as claimed in claim 22, wherein each of the elastic arms has a groove longitudinally formed in the inner surface adjacent to the engaging component.

24. The tape holding device as claimed in claim 2, wherein the holding frame has multiple skidproof bars longitudinally formed on the external surfaces of the elastic arms at intervals adjacent to the connecting segment.

25. The tape holding device as claimed in claim 3, wherein the holding frame has multiple skidproof bars longitudinally formed on the external surfaces of the elastic arms at intervals adjacent to the connecting segment.

26. The tape holding device as claimed in claim 2, wherein the holding frame has a cover transversally formed on a bottom of the connecting segment and extending to the middles of the elastic arms.

27. The tape holding device as claimed in claim 3, wherein the holding frame has a cover transversally formed on a bottom of the connecting segment and extending to the middles of the elastic arms.

28. The tape holding device as claimed in claim 3, wherein each one of the at least one engaging tab has
a connecting end connected to the inner surface of a corresponding one of the elastic arms; and
an engaging end extending inwardly to an interior of the holding frame.

29. The tape holding device as claimed in claim 28, wherein the engaging end of each one of the at least one engaging tab extends to the corresponding elastic arm at an oblique angle relative to the inner surface of the corresponding elastic arm and has an advance angle.

30. The tape holding device as claimed in claim 2 wherein the holding frame is a V-shaped elastic frame.

31. The tape holding device as claimed in claim 16, wherein the holding frame is a V-shaped elastic frame.
